(19) United States
(12) Patent Application Publication
(10) Pub. No.: US 2013/0298474 A1
(43) Pub. Date: Nov. 14, 2013

(54) CUTTING TOOL MADE OF SIALON BASED MATERIAL

(71) Applicant: Erik Osthols, Huddinge (SE)

(72) Inventor: Erik Osthols, Huddinge (SE)

(73) Assignee: SANDVIK INTELLECTUAL PROPERTY AB, Sandviken (SE)

(21) Appl. No.: 13/996,296

(22) PCT Filed: Dec. 21, 2011
(86) PCT No.: PCT/EP2011/073542

§ 371 Date: Jun. 20, 2013

(30) Foreign Application Priority Data
Dec. 22, 2010 (EP) 10196391.6

(51) Int. Cl. B23B 27/14

(52) U.S. Cl. CPC B23B 27/148
USPC 51/307

(57) ABSTRACT

The present invention relates to a ceramic material for cutting tool inserts, wherein the ceramic material is based on sialon comprising β-sialon (Si_{6-z}AL_{z}O_{Z}N_{8-z}), α-sialon, (YₓSi₁₂₋₍ₘ₊ₙ₎AI₍ₘ₊ₙ₎OₙN₁₆₋ₙ), a refractory hard phase comprising TiN, Ti(C,N), TiC, or a carbide of an element from one of groups IVb, Vb and VIb of the periodic table or a nitride of an element from one of groups IVb, Vb and VIb of the periodic table, or a combination of one or more thereof, and an intergranular amorphous or partly crystalline phase. The present invention also relates to a cutting tool insert made of said ceramic material and a method of manufac turfing the same.

### TECHNICAL FIELD

The present invention relates to a ceramic material based on sialon for cutting tool inserts and a method of manufacturing the same. The ceramic material comprises β-sialon (Si_{6-z}AL_{z}O_{z}N_{8-z}), α-sialon (YₓSi₁₂₋₍ₘ₊ₙ₎Al₍ₘ₊ₙ₎OₙN₁₆₋ₙ), an intergranular amorphous or partly crystalline phase and a refractory hard phase comprising TiN, Ti(C,N), TiC, or a carbide or nitride of an element from one of groups IVb, Vb and VIb of the periodic table or a nitride of an element from one of groups IVb, Vb and VIb of the periodic table or a combination of one or more thereof. The present invention also relates to a cutting tool insert made of said ceramic material.

### BACKGROUND

A sialon is a ceramic material consisting of the elements Si, Al, O and N, sometimes additionally stabilized by a cation Meⁿ⁺, where Me can be chosen from a large number of rare-earth metals and lanthanides, such as Y, Yb, Dy, Lu, Li, Ca, Mg, Sc etc. Besides stabilizing the α-sialon phase, the choice of metal ion (Me) also affects the properties of the intergranular phase.

A sialon is typically produced by powder metallurgical methods such as milling, pressing and sintering. The raw material is usually a powder mixture of silicon nitride, alumina and AlN or some sialon polyphase together with an oxide of the metal or lanthanide, which form a transitionary melt from which the α-sialon phase (MeₓSi₁₂₋₍ₘ₊ₙ₎Al₍ₘ₊ₙ₎OₙN₁₆₋ₙ) and the β-sialon phase (Si_{6-z}AL_{z}O_{z}N_{8-z}), and possibly other phases such as YAG (Y₃Al₅O₁₂), melilite (Y₂Si₃O₃N₄), B-phase (Y₂SiAlO₅N), 12H etc. crystallize. An intergranular phase remains between the crystalline grains after the sintering. The amount of intergranular phase produced is influenced by the composition of the raw materials used, as well as the sintering conditions.

Cutting tools made of ceramic materials are, due to their high hot hardness and thermal stability, suitable for machining work-piece materials of high hardness, high tensile strength at elevated temperatures and low heat-diffusivity. Cutting tools made of sialon based ceramic material are particularly useful for grey cast iron and for self-hardening materials such as, e.g., some types of nickel- and cobalt-based materials such as heat resistant super alloys (HRSA). Sialon based ceramic materials for cutting tools can comprise refractory hard phases for increased wear resistance.

An example of a cutting tool made of an α-sialon/β-sialon based ceramic material is disclosed in US2008119349, using Sc, Y, Dy, Yb or Lu as sintering additives, and a hard component selected from the group consisting of TiN, TiC or Ti(C,N).

Another example of a cutting tool made of an α-sialon/β-sialon based ceramic material is disclosed in GB2155007, using Ca, Li, Y, Sc, La or other lanthanides as sintering additives, also with a hard phase of carbides, nitrides and/or carbonitrides.

Another example of a cutting tool made of an α-sialon/β-sialon based ceramic material is disclosed in U.S. Pat. No. 5,432,132, which describes a ceramic material with specified relations between the weight percentages of yttrium oxide and aluminum nitride as well as TiN.

Another example of an yttrium containing TiN-reinforced α-sialon/β-sialon cutting tool is disclosed in EP1939155.

It is difficult to process sialon based ceramic materials to obtain cutting tools with high performance, and there is always a demand for cutting tools with improved wear resistance.

### SUMMARY OF THE INVENTION

An object of the present invention is to provide an improved sialon based ceramic material for a cutting tool insert. Another object of the present invention is to provide a cutting tool insert with high resistance to mechanical and chemical wear. Further another object of the present invention is to provide a cutting tool optimized for, but not limited to, machining of heat resistant super alloys (HRSAs).

These objects are achieved by the ceramic material and the cutting tool insert as defined in the independent claims. Preferred embodiments are defined in the dependent claims.

A cutting tool insert in accordance with the present invention is made of a ceramic material based on sialon. The ceramic material comprises β-sialon (Si_{6-z}AL_{z}O_{z}N_{8-z}), α-sialon (YₓSi₁₂₋₍ₘ₊ₙ₎Al₍ₘ₊ₙ₎OₙN₁₆₋ₙ), an intergranular amorphous or partly crystalline phase, a refractory hard phase comprising TiN, Ti(C,N), TiC, or a carbide of an element from one of the groups IVb, Vb and VIb of the periodic table or a nitride of an element from one of the groups IVb, Vb and VIb of the periodic table, or a combination of one or more thereof, less than 0.15 weight % of any other elements than the ones presented above and wherein said ceramic material is produced from a raw material that comprises yttrium such that 0.01<Y_{eq}<0.03, oxygen such that 0.03<O_{eq}<0.06 and aluminum such that 0.04<Al_{eq}<0.055. The Y_{eq}, O_{eq} and Al_{eq} are calculated from the total composition of the raw material as disclosed below. The “eq” stands for the calculated equivalent mole fraction of the present elements in the raw material prior to milling.

An advantage with a ceramic material for cutting tool inserts according to the present invention is its high performance in toughness-demanding applications, in particular turning operations of HRSA materials, due to good resistance to edge fractures.

The sialon based ceramic materials according to the invention are made by powder metallurgical methods such as milling, pressing and sintering. The raw material, which is the starting material, is a powder mixture of for example silicon nitride, titanium nitride, alumina, oxides or nitrides of Y, aluminum nitride, polyphase 21R, 12H, 27R or 15H, possibly dispersants and pressing agents which is milled, dried to a powder and pressed to blanks. The blanks are burnt off and then sintered in a sintering furnace. The final part of the sintering can for example take place at 1700-1900° C. under nitrogen pressure. The sintered ceramic material preferably has negligible porosity thanks to a good control of powder properties and sintering process.

The intergranular phase consists of the material that is left after the a-sialon and/or (3-sialon have crystallized from melt during sintering. The intergranular phase is amorphous or partly crystalline, preferably amorphous according to one embodiment of the invention. The composition of the intergranular phase is controlled by controlling the O-, Al- and Y-equivalents of the raw material, and ensuring, through proper processing, the maximum degree of crystallization of α- and β-sialon in the sintered ceramic material.

The traditional way to describe the structure of a sialon based ceramic material is to specify the relative amounts of the alpha and beta phases, as determined through X-ray diffraction, together with the z-value of the beta phase. As the amorphous phase is not visible using X-ray diffraction methods, the amount and composition of this phase is hard to determine, especially considering the small amounts available for analysis after sintering. The amount of amorphous phase can be estimated using image analysis of electron micrographs from an SEM (Scanning electron microscope) of a polished cross section of the ceramic material, although not with great accuracy.

The composition of sialons may be described by a multidimensional phase diagram. One way to represent this multidimensional phase diagram for the Si—Al—O—N-Me system is by using the so called “Jänecke prism”, see FIG. 1.

The ceramic material according to the present invention is defined by a calculated composition of the raw materials. The following formulas have been used:

Al_{eq}=3Alₐₜ/(3Alₐₜ+pMeₐₜ+4Siₐₜ)

Me_{eq}=pMeₐₜ/(3Alₐₜ+pMeₐₜ+4Siₐₜ)

O_{eq}=2Oₐₜ/(2Oₐₜ+3Nₐₜ)

The indices “at” and “eq” denote atomic fractions and equivalents, respectively, of the elements, as present in all raw materials used in the production of a sialon except any insoluble hard carbides and/or nitrides, such as TiN, TiC, Ti(C,N) etc. The hard phase does not melt during the sintering and does therefore not significantly influence the crystallized phases or the amorphous phases. The “p” represents the charge of the Me ion, and in the case of yttrium it is equal to 3.

The equivalent of Al, Me and 0 can be correlated to Cartesian coordinates x, y, z by the following relationships:

Al=x−(1/(3)^{1/2})z

O_{eq}=y

Me_{eq}=(2/(3)^{1/2})z

If Me is a trivalent cation, the composition of any given point in the phase diagram (Jänecke prism) is given by the formula

Si_{3(1-Aleq-Meeq)}Al_{4Aleq}Me_{4Meeq}O_{60eq}N_{4(1-Oeq)}

By using the calculated equivalents from the composition of the raw material calculated from the above relations, it is possible to get complementary information about the ceramic material, information not readily obtainable from conventional X-ray diffraction (XRD) and SEM analysis. As mentioned above, determining the composition and, especially, amount of the amorphous phase cannot be easily done using conventional methods of analysis. This is important, as it is clear that for cutting tools, the amorphous (glass) phase is a weak point, both mechanically, due to the low strength and lower melting temperature of the non-crystalline structure, and also chemically. The chemical composition of the amorphous phase directly influences the chemical wear resistance of the cutting tool. By combining conventional XRD techniques with calculations from the overall composition of the raw material, expressed as equivalents, a better characterization of the ceramic material of the cutting tool is obtained.

According to one preferred embodiment of the invention, the amount of yttrium is preferably such that 0.01<Y_{eq}<0.03, more preferably 0.02<Y_{eq}<0.03. The amount of oxygen is preferably such that 0.03<O_{eq}<0.06, more preferably 0.04<O_{eq}<0.06. The amount of aluminum is preferably such that 0.04<Al_{eq}<0.055, more preferably 0.04<Al_{eq}<0.05.

The oxygen content of the sialon based ceramic material according to the present invention is preferably low. If the milling of the raw material is performed in a water containing liquid, the milling time has to be limited to limit the increase of the oxygen content in the milled powder. Alternative milling liquids can be used such as organic solvents for example ethanol, isopropanol or cyclohexane. The raw material AlN can be used as a aluminum source with the advantage that it does not contain oxygen. AlN is not preferable when using water as a milling liquid since AlN decomposes in water.

According to one embodiment of the invention, the amount of any other elements than Si, Al, O, N, Y, Ti, C or an element from one of groups IVb, Vb and VIb of the periodic table should in the ceramic material of the insert be less than 0.15 weight %, preferably less than 0.06 weight %. These other elements can for example comprise impurities from the raw powder.

According to one embodiment of the invention the amount of crystalline phases other than α-sialon, β-sialon and TiN or any other cubic nitride or carbide hard phase in the insert bulk, not counting any coatings, is less than 1 w %, preferably less than 0.5 w %. Many other crystalline phases such as YAM, YAG, melilite etc. are detrimental to the mechanical properties of the ceramic material and the amount thereof is therefore preferably reduced.

In one embodiment of the present invention the intergranular phase is amorphous, such that no other crystalline phases than the already disclosed ones are detected with X-ray diffraction.

According to one embodiment of the invention, the composition of the β-sialon (Si_{6-z}AL_{z}O_{z}N_{8-z}) in the sintered ceramic material is such that 0≦z≦4.2, preferably ≦0.6, most preferably 0.3≦z≦0.5. The z-value in the β-sialon phase affects the hardness, toughness, and grain size distribution in the sintered ceramic material. An advantage with the preferred z value is that it gives high toughness, and improved resistance to notch wear.

According to one embodiment of the invention, the refractory hard phase comprises TiN, Ti(C,N), TiC, or a carbide of an element from one of the groups IVb, Vb and VIb (Ti, Zr, Hf, Rf, V, Nb, Ta, Db, Cr, Mo, W, Sg) of the periodic table or a nitride of an element from one of the groups IVb, Vb and VIb of the periodic table. Alternatively the hard phase can comprise a combination of different carbides, nitrides and/or carbonitrides. The primary function of the hard phase is to improve the abrasive wear resistance and increase fracture toughness of the sialon.

In one embodiment of the invention, the hard phase comprises TiN. Using TiN as a hard phase increases the toughness of the ceramic material, and it may also be beneficial for the thermal shock resistance due to its relatively high thermal conductivity. Hard phase particles such as cubic nitrides and carbides of e.g. Ti often do not form part of the melt during the sintering. This is the reason why their contribution to the overall composition of the sialon based ceramic material can be fairly easily described in terms of weight or mole fraction of the raw materials, and of the final mean grain size in the sintered ceramic material. TiN is well wetted by the melt during sintering and is bonded to the sialon material, forming an integral part of the ceramic material.

In a preferred embodiment of the invention, the amount of hard phase is >5 w % and <25 w %, preferably about 15 w %. The grain size of the hard phase can be determined from SEM micrographs, and a preferred grain size is <10 micrometers, preferably 0.5-3 micrometers and more preferably 1-2 micrometers.

The present invention also comprises a method of making a ceramic cutting tool insert of a sialon material, wherein said sialon material is produced from a raw material that comprises yttrium such that 0.01<Y_{eq}<0.03, oxygen such that 0.03<O_{eq}<0.06, and aluminum such that 0.04<Al_{eq}<0.055.

In one embodiment of the present invention, the raw material comprises Si₃N₄, Al₂O₃, Y₂O₃ and at least one selected from the group of sialon polytypes 21R (SiAl₆O₂N₆), 27R (SiAl₈O₂N₈), 12H (SiAl₅O₂N₅), 15R (SiAl₄O₂N₄) and AlN. The raw materials preferably comprises 64-83 wt % Si₃N₄, 0-2.7 wt % Al₂O₃, 5.6-7.2 wt % Y2O3, 0-6.4 wt % SiAl₆O₂N₆ and 5-25 wt % hard phase. In another embodiment said raw material further comprises TiN as the hard phase. The raw material AlN can be used as an aluminum source with the advantage that it does not contain oxygen, but with the disadvantage that water is then preferably not used as a milling liquid, since AlN decomposes in water. When the raw material comprises AlN the milling is preferably performed in an organic solvent, for example ethanol, isopropanol or cyclohexane. If the raw material comprises a combination of 21-RF, 12H, 27R, 15R and AlN, the solvent is preferably also an organic solvent.

In one embodiment of the present invention, the method comprises the steps of: milling a raw material in a liquid to form a slurry, spray drying said slurry to form granules, filling at least one form with granules and pressing the granules in said form to form a green body, sintering said green body at 1700-1900° C. under nitrogen pressure and thereby forming a ceramic cutting tool insert of a sialon material.

In one embodiment of the present invention wherein said raw material consists of Si₃N₄, Al₂O₃, Y₂O₃,SiAl₆O₂N₆ and TiN, the step of milling the raw material in a liquid to form a slurry is preferably performed in water. Water is advantageous as a milling liquid due to the simplicity of the required equipment and ventilation. Water is also preferred due to its non-toxic properties.

After sintering the blanks may be ground to a desired shape and dimension for inserts for metal cutting. The inserts are optionally provided with coatings of TiN, Ti(C,N), Al₂O₃ or (Ti,Al)N or any combination thereof as known in the art.

Other objects, advantages and novel features of the invention will become apparent from the following detailed description of the invention when considered in conjunction with the accompanying drawings and claims.

### DESCRIPTION OF DRAWINGS

FIG. 1 is a schematic presentation of the Y sialon system according to prior art at 1750° C., a so called “Jänecke prism” [Gauckler, Petzow, G., in Nitrogen Ceramics, ed. Riley, F. L., Noordhoff, Leyden p. 41 (1977)].

FIG. 2 is a SEM micrograph of a polished cross-section of a ceramic material indicating α-sialon (α), β-sialon (β), intergranular phase (IGP) and TiN (TiN) in accordance with one embodiment of the present invention.

FIG. 3 is a schematic representation of the Al_{eq}, O_{eq} and Y_{eq} values for examples A, D, E, H according to the invention, as well as for TiN-containing examples from GB2155007, U.S. Pat. No. 5,432,132 and EP1939155 in an orthogonal coordinate system where the Al_{eq}, O_{eq} and Y_{eq} represents the x, y and z-axis, respectively.

### DETAILED DESCRIPTION OF PREFERRED EMBODIMENTS

The following examples serve to illustrate the novel characteristics of the invention but are not intended to limit the scope of the invention.

Powder raw materials, according to the exemplifying compositions are shown in Table A. The raw material compositions presented in Table A represent the amount of powder by weight that is added to the slurry in the examples. The raw material 21R-F is a powder of SiAl₆O₂N₆. Due to oxidation from contact with air and moisture, the powders of Si₃N₄ and 21-RF contain additional oxygen, in the case of 21-RF in excess of the stoichiometric composition of the powder. The oxide powders of Al₂O₃ and Y₂O₃ are assumed to be fully oxidized as delivered.

According to the manufacturer the Si₃N₄ powder comprises about 0.01 weight-% oxygen, which is the value used for the element composition calculation. The 21RF powders were studied regarding their elemental composition in a LECO instrument analysis. The elemental compositions of Al, O and Y presented in Table A are based on the slightly higher values of oxygen, from the LECO measurement for 21-RF and from the manufacturer specification for Si₃N₄.

The LECO analysis is performed in a LECO TC 436DR in accordance with standard procedure for measuring the oxygen content equipped with an LECO RO-416DR oxygen analyzer.

The measured oxygen value of 21-RF is typically about 20% higher than the stoichiometric one. For the example A, the measured value is 12 weight percent while the calculated value is 10 weight percent.

The powder raw materials were milled in water to a slurry, using sialon bodies as milling media. Organic binders were mixed into the slurry, which was then granulated through spray drying. The granulated powder was cold-pressed uniaxially to form green bodies, which were then burnt off separately at 650° C. The burnt off green bodies were then sintered under nitrogen pressure at a maximum sintering temperature of 1810° C.

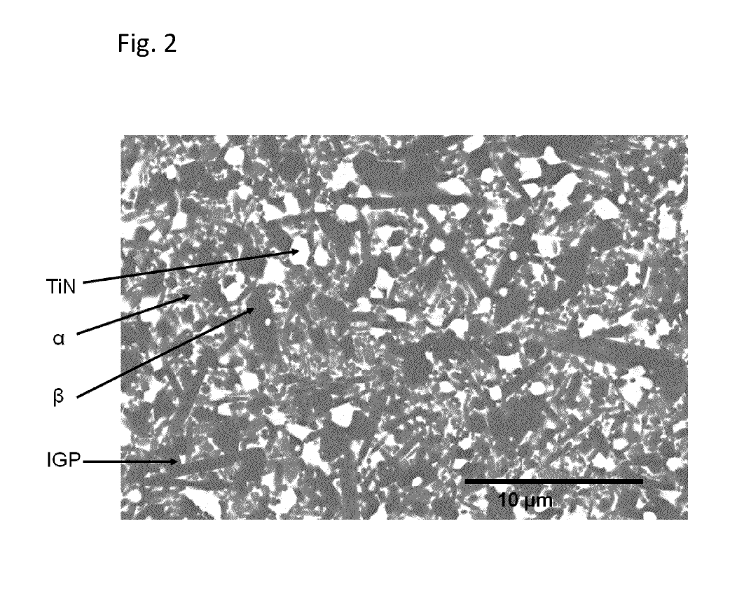

The sintered ceramic materials were analyzed metallographically and porosity was determined. X-ray diffraction patterns were used to determine the z-values and the weight percentages of the crystalline phases were determined via Rietveld refinement based on a comparison of theoretical XRD spectras with the measured spectra. The computer program Topas v2.1 from Bruker was used for the refinements. The density is measured based on Archimedes principle. Hardness and K1c-values of these sialon based ceramic materials are expected to be of levels that are typical for sialon materials or higher. The results from the analysis are shown in Table B and a SEM micrograph showing the structure of the composition A is shown in FIG. 2.

TABLE A
Composition of raw materials

| Exam- | Raw material composition, wt % | | | | | Elemental composition | | |
|---|---|---|---|---|---|---|---|---|
| ple | Si₃N₄ | Al₂O₃ | Y₂O₃ | 21R—F | TiN | Al_{eq} | O_{eq} | Y_{eq} |
| A | 72.8 | 0.0 | 6.4 | 5.8 | 15.0 | 0.048 | 0.052 | 0.025 |
| D | 72.8 | 1.2 | 6.4 | 4.5 | 15.0 | 0.049 | 0.060 | 0.025 |
| E | 67.5 | 1.1 | 6.3 | 10.1 | 15.0 | 0.095 | 0.070 | 0.025 |
| H | 68.5 | 0.5 | 5.1 | 10.9 | 15.0 | 0.096 | 0.067 | 0.020 |

TABLE B
Materials properties of sintered ceramic materials

| | | Measured | | Density |
|---|---|---|---|---|
| Example | alfa/(alfa + beta)% | z-value | Porosity¹⁾ | (g/cm3) |
| A | 11.7 | 0.5 | <A02 < B02 | 3.49 |
| D | 6.5 | 0.4 | A02 < B02 | 3.48 |
| E | 38.4 | 0.6 | A00/B00 | 3.466 |
| H | 33.0 | 0.7 | A02/B00 | 3.45 |

¹⁾According to ISO 4505 Standard on Metallographic Determination of Porosity

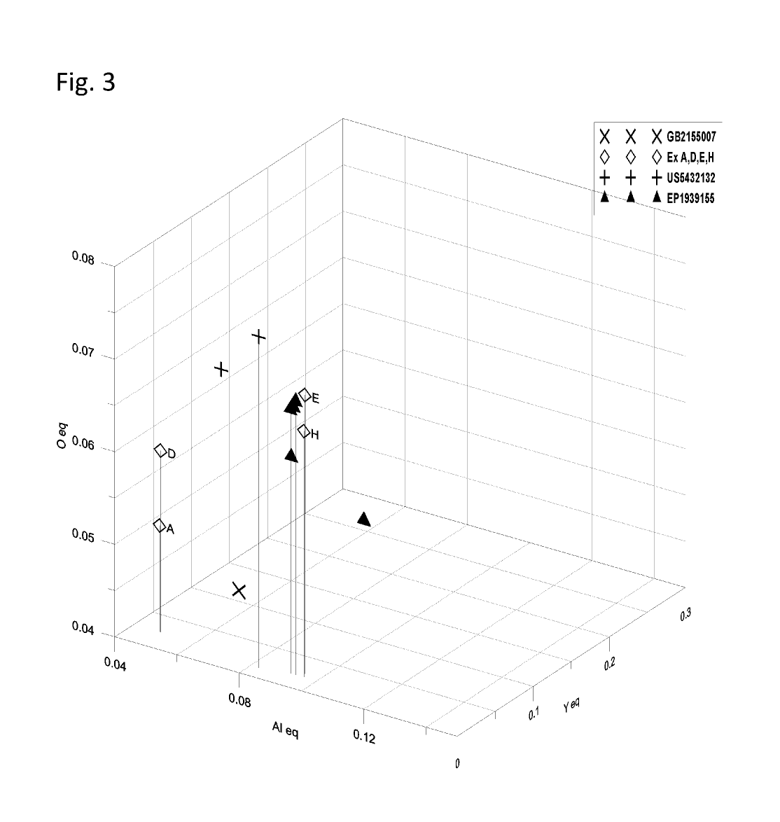

The Al_{eq}, O_{eq} and Y_{eq} for some examples disclosed in the background section, as well as example according to the invention, are plotted in an Al_{eq}, O_{eq} and Y_{eq} coordinate system in FIG. 3.

The ceramic materials according to the exemplifying compositions A, D, E and H shown in Table A, with the material properties of Table B, were ground to inserts of ISO RPGX120700T01020 type and tested in a cutting test. Said cutting test comprised a double facing operation against a shoulder in Inconel 718 using a speed of 280 m/min, feed 0.2 mm/rev and a cutting depth of 2.5 mm in each cutting direction. Coolant was used and the inserts were run in test cycles, where one test cycle corresponds to the described facing operation, in three parallel test runs, each with a fresh set of inserts. The life length of each insert, i.e. the number of cycles survived by each insert until edge breakage or a flank wear depth (VB) of 1.0 mm or more, was recorded. The results, as averages over the three parallel test runs, are shown in Table C.

TABLE C
Results from cutting tests

| Example | Average life length (no. of cycles) |
|---|---|
| A | 30.7 |
| D | 21 |
| E | 16 |
| H | 18.7 |

The examples A and D perform better than the Examples E and H. Example E and example H are examples of materials with a higher O_{eq}, a higher Al_{eq} and a higher value of alfa/(alfa+beta) % compared to the examples A and D. Example A shows a clear advantage in terms of resistance to flank wear and edge breakage compared to all the other examples.

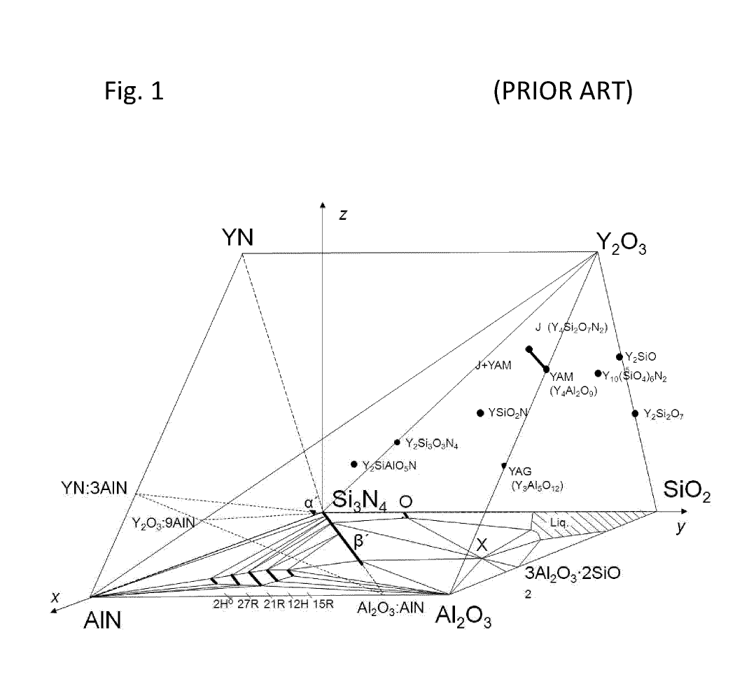

Examples A and D, which have about the same Al_{eq} and Y_{eq} values, have different O_{eq} values. This leads to different amounts of α-sialon (the change of 0.1 units in the z-value is within the error limits of the measurement), but also to differences in the amount and composition of the intergranular phase, as the position in the phase diagram shown in FIG. 1 alters. As mentioned above, the changes in amount and composition of the intergranular phase are difficult to measure, but a difference is clearly seen in the results from the cutting test, as shown in Table C. The improvement in Example A over Example D, E and G cannot exclusively be attributed to the different amounts of α-sialon. The present invention is based on the insight that the composition of the raw materials, expressed as equivalents, is one way of disclosing a sintered material with a well suited combination of crystalline and intergranular sialon phases.

While the invention has been described in connection with various exemplary embodiments, it is to be understood that the invention is not to be limited to the disclosed exemplary embodiments, on the contrary, it is intended to cover various modifications and equivalent arrangements within the appended claims.

1. A ceramic material for cutting tool inserts, wherein the ceramic material is based on sialon, the ceramic material comprising
β-sialon (Si_{6-z}AL_{z}O_{z}N_{8-z});
α-sialon (YₓSi₁₂₋₍ₘ₊ₙ₎Al₍ₘ₊ₙ₎OₙN₁₆₋ₙ);
a refractory hard phase comprising TiN, Ti(C,N), TiC, or a carbide of an element from one of groups IVb, Vb and VIb of the periodic table or a nitride of an element from one of groups IVb, Vb and VIb of the periodic table, or a combination of one or more thereof;
an intergranular amorphous or partly crystalline phase; and
less than 0.15 weight % of any other elements than the ones presented above, and wherein said ceramic material is produced from a raw material that comprises yttrium such that 0.01<Y_{eq}<0.03, oxygen such that 0.03<O_{eq}<0.06, and aluminum such that 0.04<Al_{eg}<0.055.

2. The ceramic material according to claim 1, wherein said ceramic material comprises less than 1 weight % of any other crystalline phases than α-sialon, β-sialon and said hard phase.

3. The ceramic material according to claim 1, wherein the intergranular phase is amorphous.

4. The ceramic material according to claim 1, wherein 0.3≦z≦0.5.

5. The ceramic material according to claim 1, comprising 5-25 weight % of said hard phase.

6. The ceramic material according to claim 1, wherein said hard phase comprises TiN.

7. The ceramic material according to claim 1, wherein the maximum grain size of the hard phase is less than 10 μm.

8. A cutting tool insert made of the ceramic material according to claim 1.

9. A method of making a ceramic cutting tool insert of a sialon material comprising the step of producing said sialon material from a raw material that comprises yttrium, such that 0.01<Y_{eq}<0.03; oxygen, such that 0.03<O_{eq}<0.06; and aluminum, such that 0.04<Al_{eq}<0.055.

10. A method according to claim 9, wherein said raw material comprises Si₃N₄, Al₂O₃, Y₂O₃ and at least one selected from the group of 21-RF, 12H, 27R, 15R and AlN.

11. A method according to claim 10, wherein said raw material further comprises TiN.

12. A method according to claim 9, wherein said raw material comprises 64-83 wt % Si₃N₄, 0-2.7 wt % Al₂O₃, 5.6-7.2 wt % Y2O3, 0-6.4 wt % SiAl₆O₂N₆ and 5-25 wt % hard phase.

13. A method according to claim 9, further comprising the steps of:
milling a raw material in a liquid to form a slurry;
spray drying said slurry to form granules;
filling at least one form with granules and pressing the granules in said form to form a green body;
sintering said green body at 1700-1900° C. under nitrogen pressure; and
thereby forming a ceramic cutting tool insert of a sialon based material.

14. A method according to claim 13, wherein said liquid is water and wherein said raw material consists of Si₃N₄, Al₂O₃, Y₂O₃, SiAl₆O₂N₆ and TiN.
